(19) United States
(12) Patent Application Publication
(10) Pub. No.: US 2012/0125059 A1
(43) Pub. Date: May 24, 2012

(54) LOCK

(76) Inventor: YU-TUAN LEE, Taipei City (TW)

(21) Appl. No.: 13/085,459

(22) Filed: Apr. 12, 2011

(30) Foreign Application Priority Data
Nov. 19, 2010 (TW) 099140108

(51) Int. Cl. E05B 17/22; E05B 37/00

(52) U.S. Cl. 70/332; 70/320

(57) ABSTRACT

A lock includes a combination code device, a pin, and at least one fixing unit. The combination code device has a plurality of code input units. When the code combination of the code input units is different from a preset combination, the lock is in a locked state, so the pin is engaged with the combination code device and cannot be moved or rotated. When the code combination of the code input units is the same as the preset combination, the lock is in an unlocked state, so the pin can be moved or rotated. When the fixing unit is at a first position, the code combination of the code input units can be changed; when it is at a second position, it fixes at least one code input unit, and at least part of the code combination of the code input units can not be changed.

### CROSS REFERENCE TO RELATED APPLICATIONS

This Non-provisional application claims priority under 35 U.S.C. §119(a) on Patent Application No(s). 099140108 filed in Taiwan, Republic of China on Nov. 19, 2010, the entire contents of which are hereby incorporated by reference.

### BACKGROUND OF THE INVENTION

1. Field of Invention

The present invention relates to a lock.

2. Related Art

FIGS. 1A to 1C are schematic diagrams of a conventional combination lock. FIG. 1B is an exploded view of the dials and pin of the conventional combination lock, and FIG. 1C is a schematic diagram showing that the pin is inserted into the dials. The conventional combination lock 1 includes a combination code device 11, which has a plurality of dials 111, and a pin 12. Each dial 111 has a hole O in the center thereof and a recess V located at the inner wall thereof. Thus, under a preset code combination, the pin 12 can be inserted into or pulled out of the combination code device 11.

However, this kind of combination lock 1 can be easily broken. Someone can pull the pin 12 hardly and then turn the dials 111 one by one. Accordingly, the pin 12 can enter the recesses V of the dials 111 in turn so as to confirm all of the recesses V, thereby finding out the combination code. Finally, the pin 12 can be pulled out of the dials 111.

FIGS. 2A and 2B are sectional views of different directions of a conventional cylinder lock (or pin tumbler lock). The conventional cylinder lock 2 includes a cylinder 21, a shell 22, a plurality of springs 23, a plurality of top pins 24, and a plurality of bottom pins 25. The springs 23 respectively connect the corresponding top pins 24 to the shell 22. Each top pin 24 contacts against each bottom pin 25, and they form a contact surface F. By the springs 23, the top pins 24 and the bottom pins 25 can move in the channels respectively.

As shown in FIGS. 2C and 2D, when using a correct key K to unlock the lock 2, the contact surface F of the top pin 24 and the bottom pin 25 and the junction surface 27 of the cylinder 21 and the shell 22 can be aligned. At this moment, the cylinder 21 can be rotated so as to unlock the lock 2.

However, the cylinder lock 2 can also be easily unlocked without the key K. Someone can apply a force to rotate the cylinder 21 while the lock 2 is locked. In this case, the cylinder 21 will be engaged by the bottom pins 25. Then, someone can use a proper tool to insert into the opening of the cylinder 21 and then to push upwardly the bottom pins 25 one by one. This can separate the top pins 24 and the bottom pins 25 along the junction surface 27. After separating all of the top pins 24 and the bottom pins 25, the cylinder 21 can be rotated with respect to the shell 22 so as to unlock the lock 2.

### SUMMARY OF THE INVENTION

In view of the foregoing, an objective of the present invention is to provide a more reliable lock.

To achieve the above objective, the present invention discloses a lock including a combination code device, a pin and at least one fixing unit. The combination code device has a plurality of code input units. When a code combination of the code input units is different from a preset combination, the lock is in a locked state, and when the code combination of the code input units is the same as the preset combination, the lock is in an unlocked state. The pin is engaged with the combination code device and is non-moveable or non-rotatable when the lock is in the locked state, and the pin is moveable or rotatable when the lock is in the unlocked state. The fixing unit moves between a first position and a second position. When the fixing unit is at the second position, the code combination of the code input units is changeable; otherwise, when the fixing unit is at the first position, the fixing unit fixes at least one of the code input units and at least part of the code combination of the code input units is unchangeable. The pin and the fixing unit are relatively linked.

In one embodiment of the present invention, each of the code input units includes a dial, and the pin passes through the dials.

In one embodiment of the present invention, each dial has a hole, and a first recess is configured on the inner wall of the hole.

In one embodiment of the present invention, the pin has a plurality of protrusions, and the size of the protrusion is smaller than or equal to that of the first recess.

In one embodiment of the present invention, in the locked state, the dials and the pin are engaged with each other, so that the pin is unable to be separated from the dials. In addition, in the unlocked state, the first recesses together form a channel, so that the pin is able to be moved out from the dials through the channel.

In one embodiment of the present invention, the fixing unit includes at least one tenon, which has an engaging portion and an operating portion connected to each other, and the pin has a groove. When the tenon is located at the first position, the engaging portion is located in the groove of the pin, the dial is rotatable, and the pin is non-moveable.

In one embodiment of the present invention, the fixing unit includes at least one tenon, which has an engaging portion and an operating portion connected to each other. The dial has a plurality of second recesses cooperated with the tenon. When the tenon is located at the second position, the engaging portion is at least partially located in one of the second recesses of the dial, and the dial is non-rotatable.

In one embodiment of the present invention, each of the code input units includes a push pin assembly, and the push pin assembly is at least partially located in the pin.

In one embodiment of the present invention, the push pin assembly includes a spring, a teeth-shaped top pin and a teeth-shaped bottom pin. The spring connects to the teeth-shaped top pin. At least two of the teeth-shaped top pins of the push pin assemblies or at least two of the teeth-shaped bottom pins of the push pin assemblies have different lengths.

In one embodiment of the present invention, the pin includes a cylinder body, which has a through hole. At least part of the teeth-shaped bottom pin is located in the through hole.

In one embodiment of the present invention, each of the teeth-shaped top pins and corresponding one of the teeth-shaped bottom pins have a contact surface, and the combination code device and the pin have a junction surface.

In one embodiment of the present invention, in the locked state, the contact surfaces are not aligned with the junction surface, so that the combination code device and the pin can not be relatively rotated. In the unlocked state, the contact surfaces are aligned with the junction surface, so that the combination code device and the pin can be relatively rotated.

In one embodiment of the present invention, the fixing unit includes a spring and a fixing member. When the pin is not rotated, the fixing unit is located at the first position and is not contacted with the push pin assembly, and the teeth-shaped top pin and the teeth-shaped bottom pin are moveable.

In one embodiment of the present invention, the fixing unit includes a spring and a fixing member. When the pin is rotated, the fixing unit is relocated at the second position, the spring pushes the fixing member to the push pin assembly, the fixing member fixes the teeth-shaped top pin or the teeth-shaped bottom pin, and the teeth-shaped top pin or the teeth-shaped bottom pin is non-moveable.

To achieve the above objective, the present invention also discloses a lock including a pin, a combination code device and at least a fixing unit. The combination code device has a plurality of code input units. When a code combination of the code input units is different from a preset combination, the lock is in a locked state; otherwise, when the code combination of the code input units is the same as the preset combination, the lock is in an unlocked state. The fixing unit is fixed to the code input unit and relatively linked with the code input unit. In the locked state, when applying a force to move out the pin, the pin is engaged with the fixing unit, and the code combination of the code input units is unchangeable.

In one embodiment of the present invention, in the locked state, when the pin is not moved, the pin is not engaged with the fixing unit, and the code combination of the code input units is changeable.

In one embodiment of the present invention, in the unlocked state, the pin is not engaged with the fixing unit, and the pin is moveable.

In one embodiment of the present invention, each of the code input units includes a dial, and the pin passes through the dials.

In one embodiment of the present invention, each of the dials has a hole, and a first recess is configured on the inner wall of the hole.

In one embodiment of the present invention, the pin has a plurality of protrusions, and the size of the protrusion is smaller than or equal to that of the first recess.

In one embodiment of the present invention, the fixing unit includes a hollow disk, and a plurality of third recesses are configured on the inner wall of the disk. One of the third recesses is overlapped with the first recess, and the size of the protrusion is smaller than or equal to those of the first recess and the third recesses.

In one embodiment of the present invention, in the locked state, the dials and the pin are engaged with each other. In the unlocked state, the first recesses and the third recess together form a channel.

As mentioned above, the lock of the present invention has a fixing unit for relatively linking with the pin or the code input unit. This feature can effectively protect the code lock from being broken by external force.

### BRIEF DESCRIPTION OF THE DRAWINGS

The invention will become more fully understood from the detailed description and accompanying drawings, which are given for illustration only, and thus are not limitative of the present invention, and wherein:

FIGS. 1A to 1C are schematic diagrams of a conventional combination lock; FIG. 1B is an exploded view of the dials and pin of the conventional combination lock; and FIG. 1C is a schematic diagram showing that the pin is inserted into the dials;

FIGS. 2A and 2B are sectional views of different directions of another conventional cylinder lock (or pin tumbler lock);

FIGS. 2C and 2D are schematic diagram from different angles showing that the key is inserted into the conventional cylinder lock;

FIGS. 3A and 3B are schematic diagrams of a lock according to a first embodiment of the present invention;

FIGS. 4A and 4B are schematic diagrams of a lock according to a second embodiment of the present invention, wherein FIG. 4A is a sectional view of the lock, and FIG. 4B is a sectional view along line A-A of FIG. 4A; and

FIGS. 5A to 5C are schematic diagrams of a lock according to a third embodiment of the present invention, wherein FIG. 5A is a perspective view showing a dial, a fixing unit and a pin, FIG. 5B is a sectional view showing three dials and three fixing units, and FIG. 5C is a sectional view along line B-B of FIG. 5B.

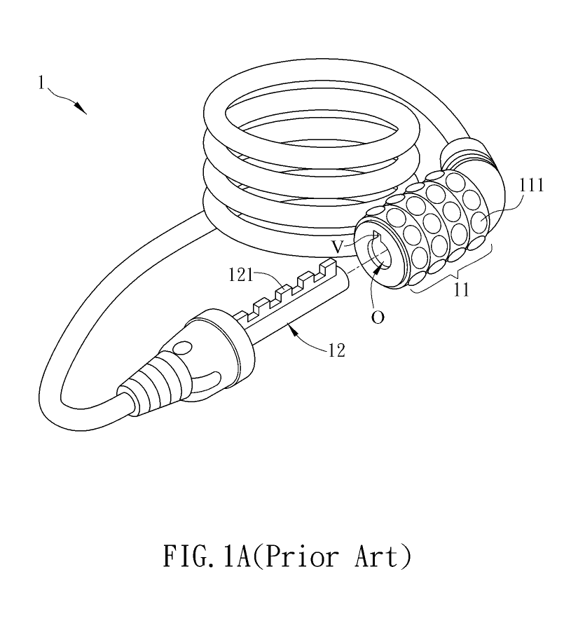

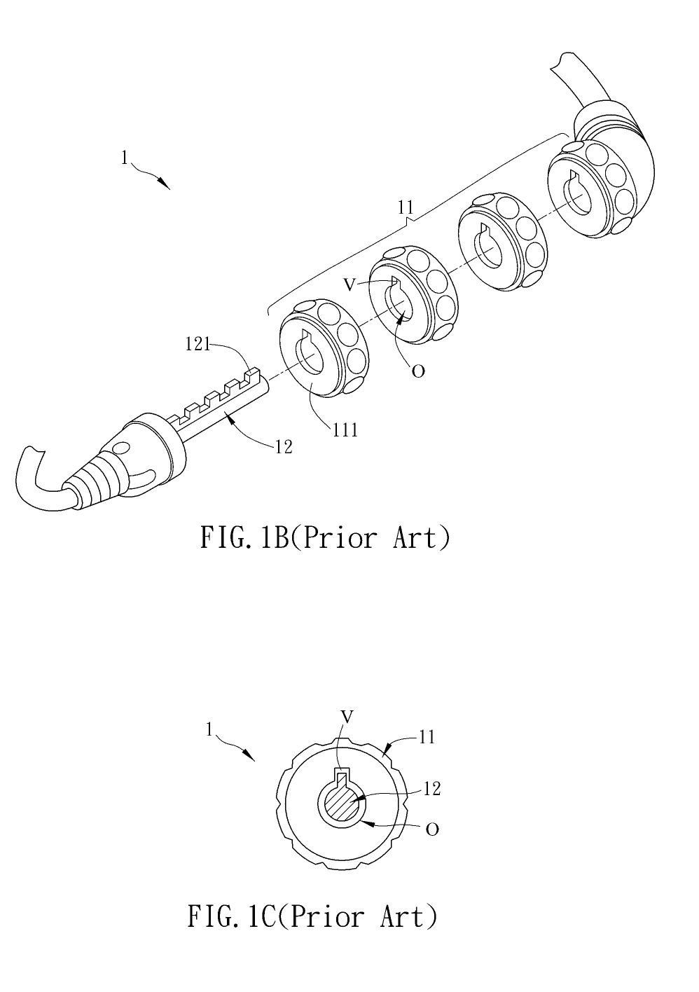

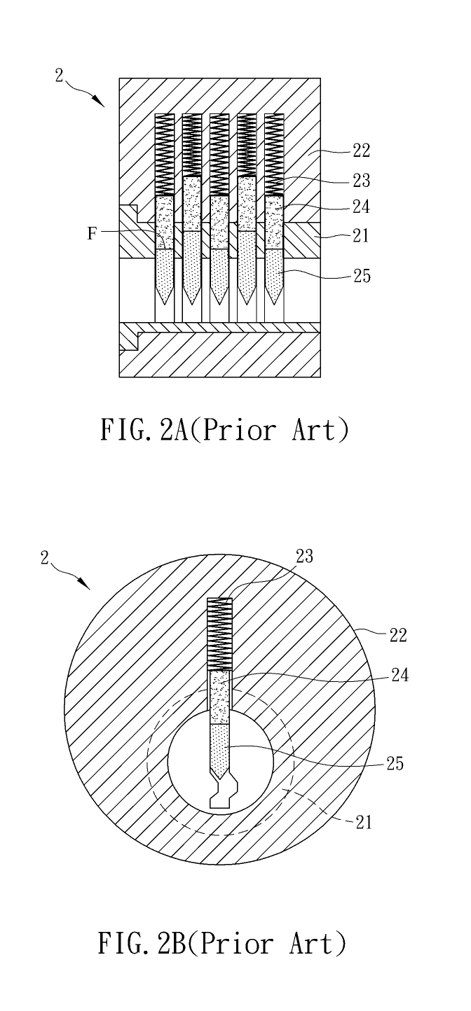

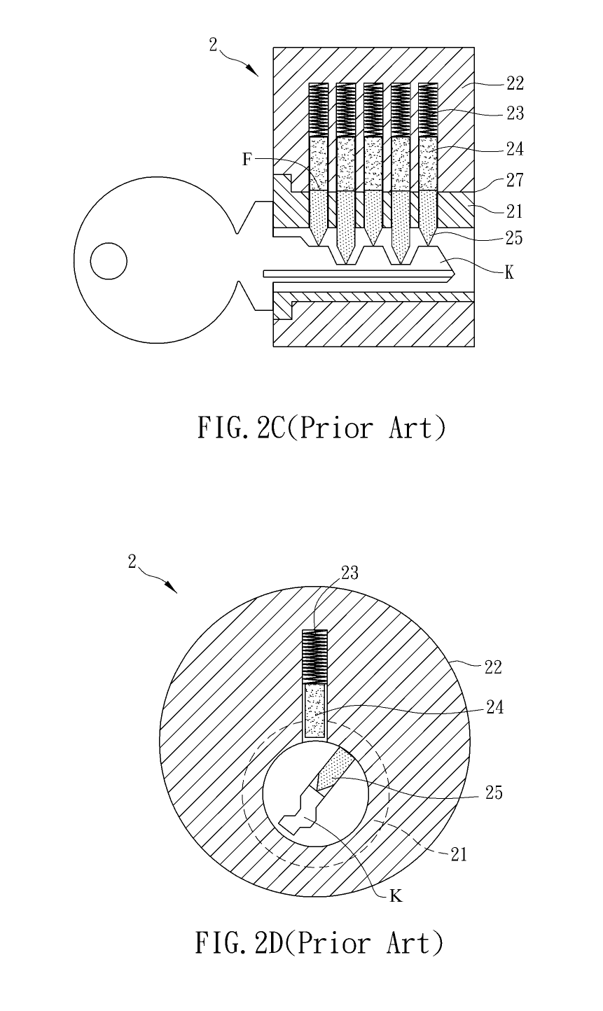

### DETAILED DESCRIPTION OF THE INVENTION

The present invention will be apparent from the following detailed description, which proceeds with reference to the accompanying drawings, wherein the same references relate to the same elements.

### First Embodiment

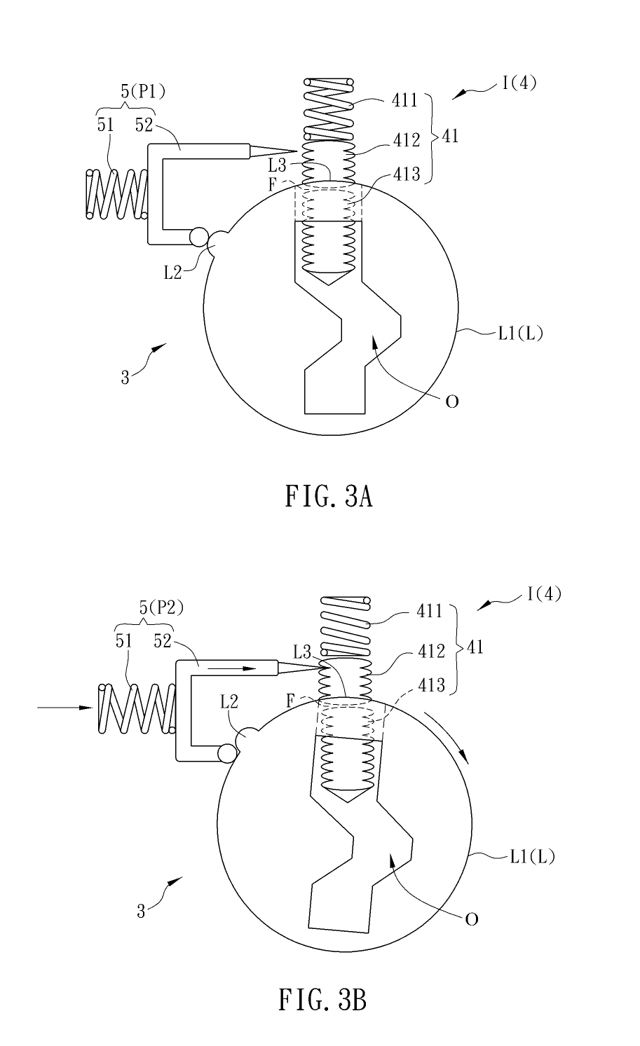

FIGS. 3A and 3B are schematic diagrams of a lock 3 according to a first embodiment of the present invention. The lock 3 includes a combination code device 4, a pin L, and at least one fixing unit 5. In this embodiment, the lock 3 is an example of cylinder lock.

The combination code device 4 includes a plurality of code input units 1, and each code input unit 1 includes a push pin assembly 41. Only one code input unit 1 and one fixing unit 5 are illustrated in FIGS. 3A and 3B, but this invention is not limited to this. Each push pin assembly 41 includes a spring 411, a teeth-shaped top pin 412 and a teeth-shaped bottom pin 413. The spring 411 connects the teeth-shaped top pin 412 to the shell (not shown) of the lock 3. At least two of the teeth-shaped top pins 412 of the push pin assemblies 41 or at least two of the teeth-shaped bottom pins 413 of the push pin assemblies 41 have different lengths. According to the teeth-shaped top pins 412 and the teeth-shaped bottom pins 413 of different lengths, their combinations of different lengths can be obtained. Thus, at least two of the contact surfaces F between the teeth-shaped top pins 412 and the teeth-shaped bottom pins 413 in the push pin assemblies 41 are located at different planes, thereby constructing the code combination. The teeth shape of the teeth-shaped top pins 412 and the teeth-shaped bottom pins 413 represents that the top pins 412 and bottom pins 413 have grooves, and their shape can be formed by configuring several regular or irregular grooves.

The pin L includes a cylinder body L1, which has a through hole O. The push pin assembly 41 is at least partially located on the pin L. For example, since the teeth-shaped bottom pin 413 is connected with the teeth-shaped top pin 412, the teeth-shaped bottom pin 413 is partially located in the through hole O. A junction surface L3 is located between the combination code device 4 and the pin L, so that the junction surface L3 is substantially the external surface of the cylinder body L1. When the lock 3 is in the locked state, the contact surfaces F between the teeth-shaped top pins 412 and the teeth-shaped bottom pins 413 in the push pin assemblies 41 are not aligned with the junction surface L3, which means the code combination (the positions or heights of the contact surfaces F) is not the same as a preset combination. In this case, if the pin L is rotated, the teeth-shaped top pins 412 and the teeth-shaped bottom pins 413 will be engaged with the pin L. Accordingly, the combination code device 4 and the pin L can not be relatively rotated. Moreover, if a key with the proper shape is inserted into the through hole O of the pin L, it can push the contact surfaces F between the teeth-shaped top pins 412 and the teeth-shaped bottom pins 413 to proper positions respectively. In this case, the contact surfaces F are aligned with the junction surface L3, which means the code combination of the code input units 1 is the same as the preset combination, so as to switch the lock 3 into the unlocked state. In the unlocked state, the combination code device 4 and the pin L can be relatively rotated.

The fixing unit 5 includes a spring 51 and a fixing member 52, which are connected to each other. Based on the force applied by the spring 51, the fixing unit 5 can be moved between a first position P1 and a second position P2. During the locked state and the pin L is not rotated, the fixing unit 5 is located at the first position P1 (see FIG. 3A). In this case, the fixing member 52 contacts with a contact portion L2 of the cylinder body L1 of the pin L so as to compress the spring 51. Thus, the spring 51 can have a restore force. In this embodiment, the contact portion L2 is a protrusion that is protruded from the periphery of the pin L. As mentioned above, the fixing unit 5 does not contact with the push pin assembly 41, and the code input units 1 with the teeth-shaped top pins 412 and the teeth-shaped bottom pins 413 are moveable. During the unlocked state and the pin L is rotated, the contact portion L2 is misaligned with the fixing member 52, so that they do not contact with each other. Based on the restore force of the spring 51, the fixing unit 5 can be pushed to the second position P2 (see FIG. 3B). In this case, the spring 51 push the fixing member 52 to contact with the push pin assembly 41, and the fixing member 52 can fix the teeth-shaped top pin 412 or the teeth-shaped bottom pin 413 of at least one code input unit 1. For example, as shown in FIG. 3B, the fixing member 52 has a sharp tip for engaging with the groove of one teeth-shaped top pin 412 or one teeth-shaped bottom pin 413. Thus, the teeth-shaped top pin 412 and the teeth-shaped bottom pin 413 can not move upwardly and downwardly, so that the code combination can not be changed. To be noted, the fixing unit 5 may fix multiple push pin assemblies 41, but the fixing unit 5 of this embodiment fixes only one push pin assembly 41 for example. In this embodiment, the spring 51 of the fixing unit 5 is triggered by the height difference between the fixing member 52 and the contact portion L2, which are misaligned, so as to push the fixing member 52. Of course, the operation mechanism of the fixing unit 5, which is controlled by the rotation or non-rotation of the pin L, can also be controlled by other mechanical mechanism such as the manual or automatic tenon, button or bolt. Otherwise, any mechanical mechanism capable of carrying out the link between the pin L and the fixing unit 5 should be involved in the scope of the present invention.

When the lock 3 is in the locked state and the fixing unit 5 is at the first position P1, if the user inserts the correct key, the contact surfaces F between the teeth-shaped top pins 412 and the teeth-shaped bottom pins 413 of the push pin assemblies 41 can be pushed to the junction surface L3, thereby finishing the correct code combination. Then, the lock 3 can be unlocked by rotating the pin L. In this case, the code combination is correct, so that the movement of the fixing unit 5 can not affect the unlock procedure. Of course, if a thief tries to apply a force to find out the code combination of the combination code device 4, the pin L will be moved to the second position P2 from the first position P1 while the pin L is forced to rotate. Then, the fixing unit 5 can fix the code input units 1, so that the code combination can not be changed anymore and the unlock procedure can not be performed. This mechanism can prevent thieves.

### Second Embodiment

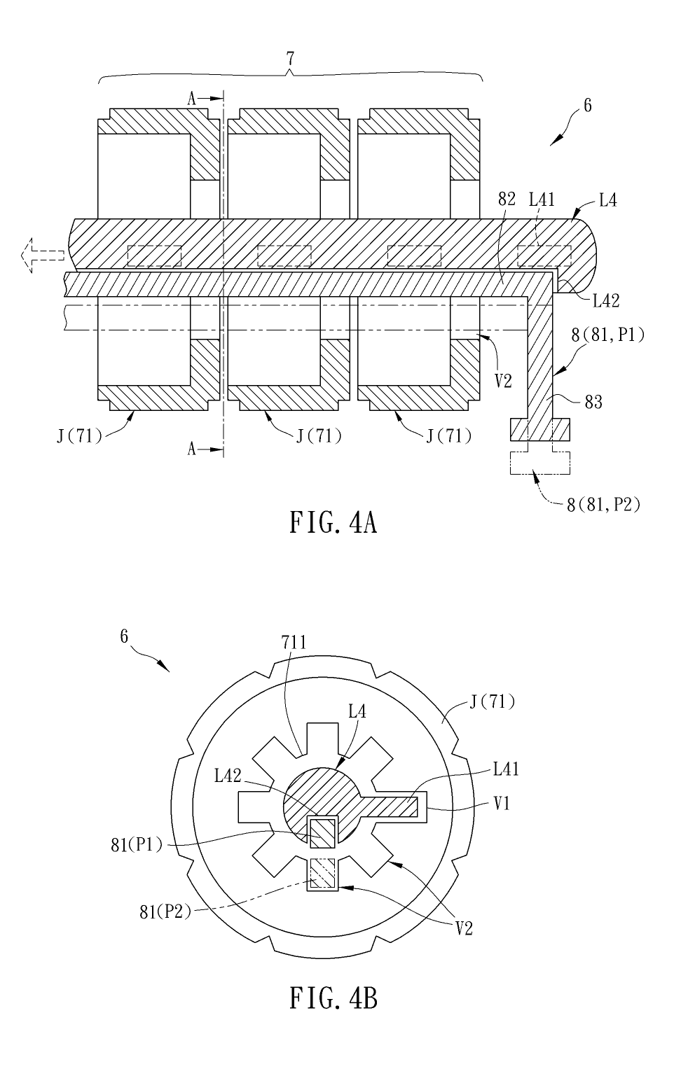

FIGS. 4A and 4B are schematic diagrams of a lock 6 according to a second embodiment of the present invention, wherein FIG. 4A is a sectional view of the lock 6, and FIG. 4B is a sectional view along line A-A of FIG. 4A. The lock 6 includes a combination code device 7, a pin L4, and at least one fixing unit 8. In this embodiment, the lock 6 is a combination lock with dials for example.

The combination code device 7 includes a plurality of code input units J, and each code input unit J includes a dial 71 for example. Three code input units J and one fixing unit 8 are illustrated in FIG. 4A and FIG. 4B, but this invention is not limited to this. Each dial 71 includes a hole 711, and a first recess V1 is configured on the inner wall of the hole 711. The dials 71 can be rotated relatively, and the outer surfaces thereof can be configured with a plurality of different digits or symbols, so that the user can easily remember the relative positions of the dials 71. The user can define any one of the digits or symbols to be corresponding to the first recess V1. Herein, the defined digits or symbols corresponding to the first recesses V1 are the preset code combination. By relatively rotating the dials 71, the user can input different code combinations.

The pin L4 is inserted through the holes 711 so as to pass through the dials 71. The pin L4 has a plurality of protrusions L41, which are aligned in one dimension for example, and the size of each protrusion L41 is smaller than or equal to that of the first recess V1 of each dial 71. In the locked state, the inner wall of the dials 71 and the pin L4 are engaged with each other, and at least one recess V1 is not aligned with the protrusion L41 of the pin L4. This means that the inputted code combination (the relative positions of the dials 71) is not the same as the preset one, so that the pin L4 is unable to be separated from the dials 71. The direction for pulling the pin L4 out of the dials 71 is as the dotted arrow shown in FIG. 4A, and it is substantially parallel to the stacking direction of the dials 71. Thus, the lock 6 can not be unlocked. In addition, in the unlocked state, the first recesses V1 together form a channel, which means the inputted code combination is the same as the preset one. Thus, the pin L4 is able to be moved out from the dials 71, thereby finishing the unlock procedure.

The fixing unit 8 includes at least one tenon 81, which has an engaging portion 82 and an operating portion 83 connected to each other. Herein, the engaging portion 82 and the operating portion 83 are substantially perpendicular to each other for example. The fixing unit 8 can be moved between a first position P1 and a second position P2. In this embodiment, the tenon 81 moves between the first position P1 and the second position P2 for example. The pin L4 has a groove L42 on the lengthwise direction thereof. When the tenon 81 is located at the first position P1, the engaging portion 82 is located in the groove L42 of the pin L4 so as to be engaged with the pin L4. The tenon 81 engaged with the pin L4 does not stop the rotation of the dials 71 (see FIG. 4B), so that the dials 71 are rotatable and the pin L4 is non-moveable. In this embodiment, the dial 71 has a plurality of second recesses V2 cooperated with the tenon 81. Herein, the shape of the second recess V2 is different from that of the first recess V1. When the tenon 81 is located at the second position P2, the engaging portion 82 is at least partially located in one of the second recesses V2 of the dial 71. Thus, when the tenon 81 is located at the second position P2, the dials 71 are non-rotatable and the pin L4 is moveable. Herein, the movement direction of the pin L4 is substantially perpendicular to the rotation plane of the dial 71.

When the lock 6 is in the locked state, the tenon 81 of the fixing unit 8 must be pushed to the first position P1 before performing the unlock procedure. Then, the dials 71 can be rotated to the correct positions so as to finish the correct code combination. Finally, the tenon 81 is moved to the second position P2 and the pin L4 is pulled out, thereby finishing the unlock procedure. If a thief tries to apply a force on the pin L4 to find out the code combination of the dials 71 and pull out the pin L4 in the locked state, he/she is unable to directly unlock the lock 6 while the tenon 81 of the fixing unit 8 stays at the first or second position P1 or P2. Due to the relative linking between the pin L4 and the fixing unit 8, only the dials 71 can be rotated but the pin L4 can not be moved as the tenon 81 of the fixing unit 8 is in the first position P1. When the tenon 81 is in the second position P2, the pin L4 can be moved but the dials 71 can not be rotated. Consequently, the pin L4 and the fixing unit 8 as well as their relative linking can efficiently prevent the code of the lock 6 from being broken by thieves.

### Third Embodiment

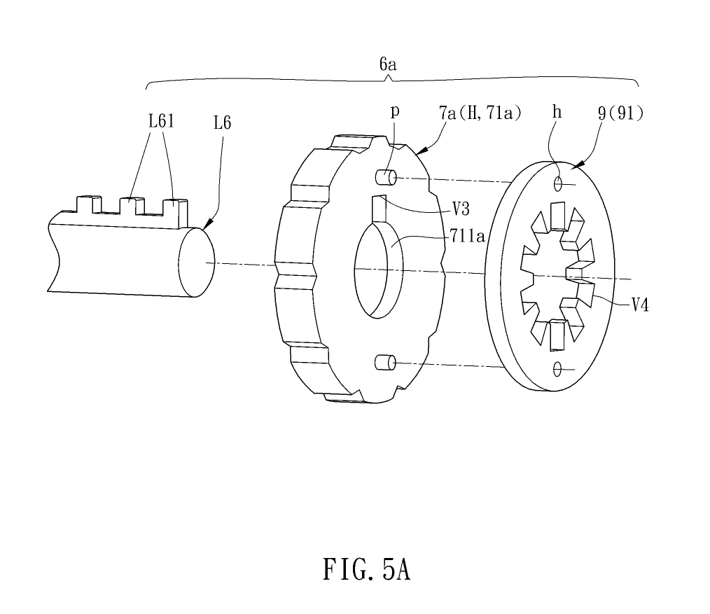

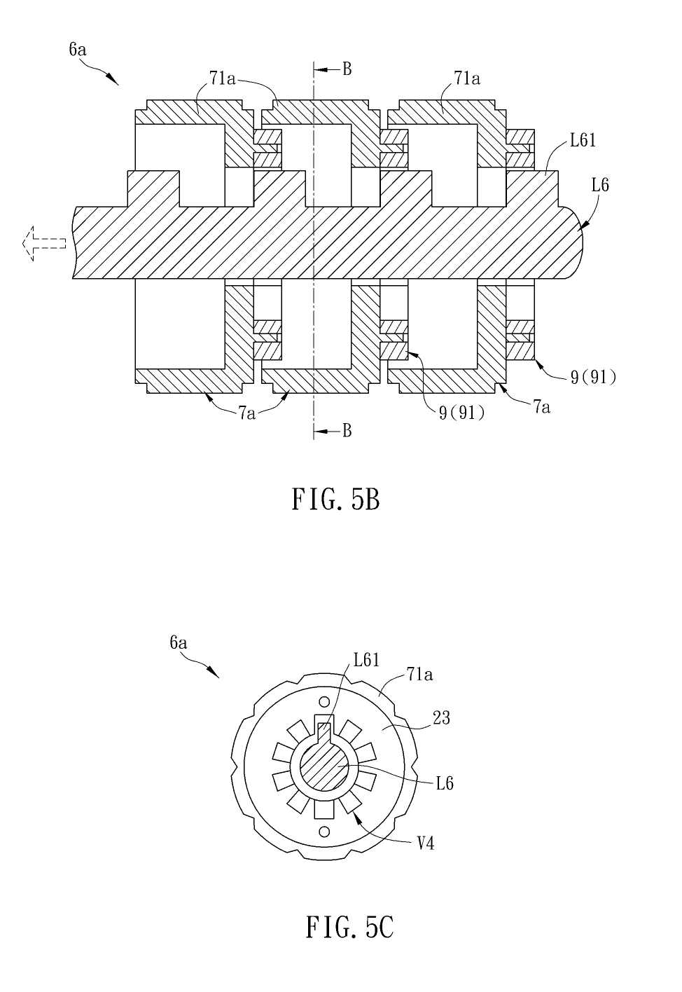

FIGS. 5A to 5C are schematic diagrams of a lock 6a according to a third embodiment of the present invention, wherein FIG. 5A is a perspective view showing only a dial, a fixing unit and a pin, FIG. 5B is a sectional view showing three dials and three fixing units, and FIG. 5C is a sectional view along line B-B of FIG. 5B. The lock 6a includes a combination code device 7a, a pin L6, and at least one fixing unit 9. In this embodiment, the lock 6a is a combination lock with dials for example.

The combination code device 7a includes a plurality of code input units H, and each code input unit H includes a dial 71a for example. Multiple dials 71a may be cooperated with multiple fixing units 9 respectively; otherwise, at least one of multiple dials 71a may be cooperated with one fixing unit 9. Each dial 71a includes a hole 711a, and a first recess V3 is configured on the inner wall of the hole 711a. The dials 71a can be rotated relatively and the outer surfaces thereof can be configured with a plurality of different digits or symbols, so that the user can easily remember the relative positions of the dials 71a. The user can define any one of the digits or symbols to be corresponding to the first recess V3. Herein, the defined digits or symbols corresponding to the first recesses V3 are the preset code combination. By relatively rotating the dials 71a, the user can input different code combinations.

The pin L6 is inserted through the holes 711a so as to pass through the dials 71a. The pin L6 has a plurality of protrusions L61, which are aligned in one dimension for example, and the size of each protrusion L61 is smaller than or equal to that of the first recess V3 of each dial 71a. In the locked state, the inner wall of the dials 71a and the pin L6 are engaged with each other, and at least one recess V3 is not aligned with the protrusion L61 of the pin L6. This means that the inputted code combination (the relative positions of the dials 71a) is not the same as the preset one, so that the pin L6 is unable to be separated from the dials 71a. The direction for pulling the pin L6 out of the dials 71a is as the dotted arrow shown in FIG. 5B. Thus, the lock 6a can not be unlocked. In addition, in the unlocked state, the first recesses V3 together form a channel, which means the inputted code combination is the same as the preset one. Thus, the pin L6 is able to be moved out from the dials 71a, thereby finishing the unlock procedure.

The fixing unit 9 is fixed to the dials 71a and includes a hollow disk 91. A plurality of third recesses V4 are configured on the inner wall of the disk 91, and the number of the third recesses V4 may be the same as that of digits or symbols on the dial 71a. For example, the outer surface of the dial 71a is configured with digits from 0 to 7, and there are eight recesses V4 configured on the inner wall of the disk 91. The disk 91 and the dials 71a are fixed together by engaging, adhering or screwing. In this embodiment, the hollow disk 91 has a through hole h and the dial 71a has a protruding portion p, which is engaged with the through hole h. Accordingly, the fixing unit 9 can be fixed with the combination code device 7a, and one of the third recesses V4 of the disk 91 can be aligned with the corresponding first recess V3 on the dial 71a.

When the lock 6a is in the locked state, the dials 71a of the code input unit H can be rotated to the correct positions so as to input the correct code combination. Due to the relative linking of the code input unit H and the fixing unit 9, one of the third recesses V4 of the disk 91 can be aligned with the corresponding first recess V3 of the dial 71a, so that the pin L6 can pass through the third recess V4 and the first recess V3, thereby finishing the unlock procedure. If a thief tries to apply a force on the pin L6 to find out the code combination of the dials 71a and pull out the pin L6 in the locked state, the pulled pin L6 may pass through a third recess V4 of the fixing unit 9, which is not the one aligned with the corresponding first recess V3 (only one specific third recess V4 can be aligned with the corresponding first recess V3). Thus, the pin L6 can not be moved toward the dial 71a anymore, so it will be jammed between the third recess V4 and the dial 71a. Accordingly, the thief can not rotate the dials 71a to unlock the lock 6a. Consequently, the code input unit 7a and the fixing unit 9 as well as their relative linking can efficiently prevent the code of the lock 6a from being broken by thieves.

To be noted, any current combination lock such as the button combination lock or the mechanical combination lock can be manufactured accordingly the principle of the present invention, thereby making the combination lock more secure.

To sum up, the combination lock or cylinder lock of the present invention has a fixing unit, which allows the change of the code combination or the arrangement of the top and/or bottom pin only when the pin or cylinder body as well as the fixing unit is located at the specific position. Compared with the prior art, the present invention can effectively prevent the lock from being unlocked by the external force.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A lock comprising:
a combination code device having a plurality of code input units, wherein when a code combination of the code input units is different from a preset combination, the lock is in a locked state, and when the code combination of the code input units is the same as the preset combination, the lock is in a unlocked state;
a pin, wherein the pin is engaged with the combination code device and is non-moveable or non-rotatable when the lock is in the locked state, and the pin is moveable or rotatable when the lock is in the unlocked state; and
at least a fixing unit moving between a first position and a second position;
wherein, the code combination of the code input units is changeable when the fixing unit is at the first position, the fixing unit fixes at least one of the code input units and at least part of the code combination of the code input units is unchangeable when the fixing unit is at the second position, and the pin and the fixing unit are relatively linked.

2. The lock according to claim 1, wherein each of the code input units comprises a dial, and the pin passes through the dials.

3. The lock according to claim 2, wherein each of the dials has a hole, and a first recess is configured on the inner wall of the hole.

4. The lock according to claim 3, wherein the pin has a plurality of protrusions, and the size of the protrusion is smaller than or equal to that of the first recess.

5. The lock according to claim 3, wherein:
in the locked state, the dials and the pin are engaged with each other, so that the pin is unable to be separated from the dials; and
in the unlocked state, the first recesses together form a channel, so that the pin is able to be moved out from the dials.

6. The lock according to claim 2, wherein the fixing unit comprises at least one tenon, the tenon has an engaging portion and an operating portion connected to each other, the pin has a groove, and when the tenon is located at the first position, the engaging portion is located in the groove of the pin.

7. The lock according to claim 6, wherein the dial is rotatable, and the pin is non-moveable.

8. The lock according to claim 2, wherein the fixing unit comprises at least one tenon, the tenon has an engaging portion and an operating portion connected to each other, the dial has a plurality of second recesses cooperated with the tenon, and when the tenon is located at the second position, the engaging portion is at least partially located in one of the second recesses of the dial.

9. The lock according to claim 8, wherein the dial is non-rotatable.

10. The lock according to claim 1, wherein each of the code input units includes a push pin assembly, and the push pin assembly is at least partially located in the pin.

11. The lock according to claim 10, wherein the push pin assembly comprises a spring, a teeth-shaped top pin and a teeth-shaped bottom pin, the spring connects to the teeth-shaped top pin, and at least two of the teeth-shaped top pins of the push pin assemblies or at least two of the teeth-shaped bottom pins of the push pin assemblies have different lengths.

12. The lock according to claim 10, wherein the pin comprises a cylinder body, the cylinder body has a through hole, and at least part of the teeth-shaped bottom pin is located in the through hole.

13. The lock according to claim 11, wherein each of the teeth-shaped top pins and corresponding one of the teeth-shaped bottom pins have a contact surface, and the combination code device and the pin have a junction surface.

14. The lock according to claim 13, wherein:
in the locked state, the contact surfaces are not aligned to the junction surface, so that the combination code device and the pin can not be relatively rotated; and
in the unlocked state, the contact surfaces are aligned to the junction surface, so that the combination code device and the pin can be relatively rotated.

15. The lock according to claim 10, wherein the fixing unit comprises a spring and a fixing member, and when the pin is not rotated, the fixing unit is located at the first position and is not contacted with the push pin assembly, and the teeth-shaped top pin and the teeth-shaped bottom pin are moveable.

16. The lock according to claim 10, wherein the fixing unit comprises a spring and a fixing member, and when the pin is rotated, the fixing unit is relocated at the second position, the spring pushes the fixing member to the push pin assembly, the fixing member fixes the teeth-shaped top pin or the teeth-shaped bottom pin, and the teeth-shaped top pin or the teeth-shaped bottom pin is non-moveable.

17. A lock comprising:
a pin;
a combination code device having a plurality of code input units, wherein when a code combination of the code input units is different from a preset combination, the lock is in a locked state, and when the code combination of the code input units is the same as the preset combination, the lock is in an unlocked state; and
at least a fixing unit fixed to the code input unit and relatively linked with the code input unit;
wherein, in the locked state, when applying a force to move out the pin, the pin is engaged with the fixing unit, and the code combination of the code input units is unchangeable.

18. The lock according to claim 17, wherein, in the locked state, when the pin is not moved, the pin is not engaged with the fixing unit, and the code combination of the code input units is changeable.

19. The lock according to claim 17, wherein, in the unlocked state, the pin is not engaged with the fixing unit, and the pin is moveable.

20. The lock according to claim 17, wherein each of the code input units comprises a dial, and the pin passes through the dials.

21. The lock according to claim 17, wherein each of the dials has a hole, and a first recess is configured on the inner wall of the hole.

22. The lock according to claim 21, wherein the pin has a plurality of protrusions, and the size of the protrusion is smaller than or equal to that of the first recess.

23. The lock according to claim 21, wherein the fixing unit comprises a hollow disk, a plurality of third recesses are configured on the inner wall of the disk, one of the third recesses is overlapped with the first recess, and the size of the protrusion is smaller than or equal to those of the first recess and the third recess.

24. The lock according to claim 23, wherein:
in the locked state, the dials and the pin are engaged with each other; and
in the unlocked state, the first recesses and the third recess together form a channel.
